(19) United States
(12) Patent Application Publication
(10) Pub. No.: US 2014/0081442 A1
(43) Pub. Date: Mar. 20, 2014

(54) PRODUCT QUALITY IMPROVEMENT FEEDBACK METHOD

(71) Applicant: ASKEY COMPUTER CORP., New Taipei City (TW)

(72) Inventor: Yu-Liang Chang, New Taipei City (TW)

(73) Assignee: ASKEY COMPUTER CORP., NEW TAIPEI CITY (TW)

(21) Appl. No.: 13/714,427

(22) Filed: Dec. 14, 2012

(30) Foreign Application Priority Data
Sep. 18, 2012 (TW) 101134177

(51) Int. Cl. G06F 17/00

(52) U.S. Cl. CPC G06F 17/00
USPC 700/108

(57) ABSTRACT

A product quality improvement feedback method is provided. The method includes the following steps. Provide a first checklist, a second checklist, and a third checklist in a design period, a trial production period, and a mass production period respectively. Execute a failure mode and effects analysis to the first checklist, the second checklist, and the third checklist so as to obtain a risk priority number respectively. When the first risk priority number is greater than a specific value, feedback each result of the failure mode and effects analyses to the first checklist, the second checklist, the third checklist, a design list, a trial production list or a mass production list.

### CROSS-REFERENCE TO RELATED APPLICATION

This application claims the priority benefit of Taiwan application serial no. 101134177, filed on Sep. 18, 2012. The entirety of the above-mentioned patent application is hereby incorporated by reference herein and made a part of this specification.

### BACKGROUND OF THE INVENTION

1. Field of the Invention

The present invention generally relates to a product quality improvement method, in particular, to a product quality improvement feedback method.

2. Description of Related Art

Generally speaking, a product in a design and manufacturing periods may encounter many problems to be solved. At present, after the encountered problems in each period are solved, the same problems can not be avoided effectively because there is no mechanism available for providing the feedbacks or updates in each period from the problems and the solutions during the product design and manufacturing processes. Therefore, in a follow-up design or manufacturing process for other products, a design side or a manufacturing side may require solving the same or similar problems repeatedly, which wastes a great deal of manpower and resources.

### SUMMARY OF THE INVENTION

Accordingly, the present invention is directed to a product quality improvement feedback method integrating problems encountered in each period to related tools which is applicable to other products so as to avoid solving a repeated problem causing resource wastes.

The present invention is directed to a product quality improvement feedback method including the following steps. Provide a first checklist in a design period. Execute a first failure mode and effects analysis (FMEA) to the first checklist so as to obtain a first risk priority number (RPN). Provide a feedback of a result of the first FMEA to the first checklist or a design list if the first RPN is greater than a first specific value. Provide a second checklist in a trial production period. Execute a second FMEA to the second checklist so as to obtain a second RPN. Provide a feedback of a result of the second FMEA to the first checklist, the design list, the second checklist, or a trial production list if the second RPN is greater than a second specific value. Provide a third checklist in a mass production period. Execute a third FMEA to the third checklist so as to obtain a third RPN. Provide a feedback of a result of the third FMEA to the first check list, the design list, the second checklist, the trial production list, the third checklist or a mass production list if the third RPN is greater than a third specific value.

According to an embodiment of the present invention, the step of providing a first checklist includes building the first checklist via a quality function deployment (QFD) methodology.

According to an embodiment of the present invention, the first FMEA includes a design failure mode and effects analysis (DFMEA).

According to an embodiment of the present invention, the design list includes a design guideline and a process quality control plan (PQCP).

According to an embodiment of the present invention, the first FMEA includes a process failure mode and effects analysis (PFMEA).

According to an embodiment of the present invention, the design list includes a design for excellent (DFX) review and a PQCP.

According to an embodiment of the present invention, the second checklist includes a major issue list.

According to an embodiment of the present invention, the second FMEA includes a DFMEA.

According to an embodiment of the present invention, the trail production list includes a design guideline, a PQCP, a standard operation procedure (SOP), and a standard inspection procedure (SIP).

According to an embodiment of the present invention, the second FMEA includes a PFMEA.

According to an embodiment of the present invention, the trail production list includes a DFX review, a PQCP, a SOP, and a SIP.

According to an embodiment of the present invention, the third checklist includes a return materiel authorization (RMA) or a major issue list.

According to an embodiment of the present invention, the third FMEA includes a DFMEA.

According to an embodiment of the present invention, the mass production list includes a design guideline.

According to an embodiment of the present invention, the third FMEA includes a PFMEA.

According to an embodiment of the present invention, the mass production list includes a DFX review, a PQCP, a SOP, or a SIP.

According to an embodiment of the present invention, the first specific value, the second specific value, and the third specific value are 100.

Based on the above, the product quality improvement feedback method in the present invention provides a checklist and executes a FMEA to a design side and a manufacturing side in a design period, a trial production period, and a mass production period respectively so as to obtain a RPN from each of the periods. If the RPN is greater than a specific value, then a result of the FMEA will be feedback to tools such as the checklist, a design list, a trial production list, or a mass production list of a product so as to integrate problems and solutions systematically. Therefore, other products in a follow-up production may prevent the problem and avoid repeatedly solving the same problem that causes resource wastes.

In order to make the aforementioned and other objects, features and advantages of this invention comprehensible, a preferred embodiment accompanied with figures is described in detail below.

### BRIEF DESCRIPTION OF THE DRAWINGS

FIG. 1 is a flow diagram of a product quality improvement feedback method in accordance with an embodiment in the present invention.

FIG. 2 is a flow diagram of the design period of the product quality improvement feedback method in FIG. 1.

FIG. 3 is a flow diagram of the trail production period of the product quality improvement feedback method in FIG. 1.

FIG. 4 is a flow diagram of the mass production period of the product quality improvement feedback method in FIG. 1.

### DESCRIPTION OF THE EMBODIMENTS

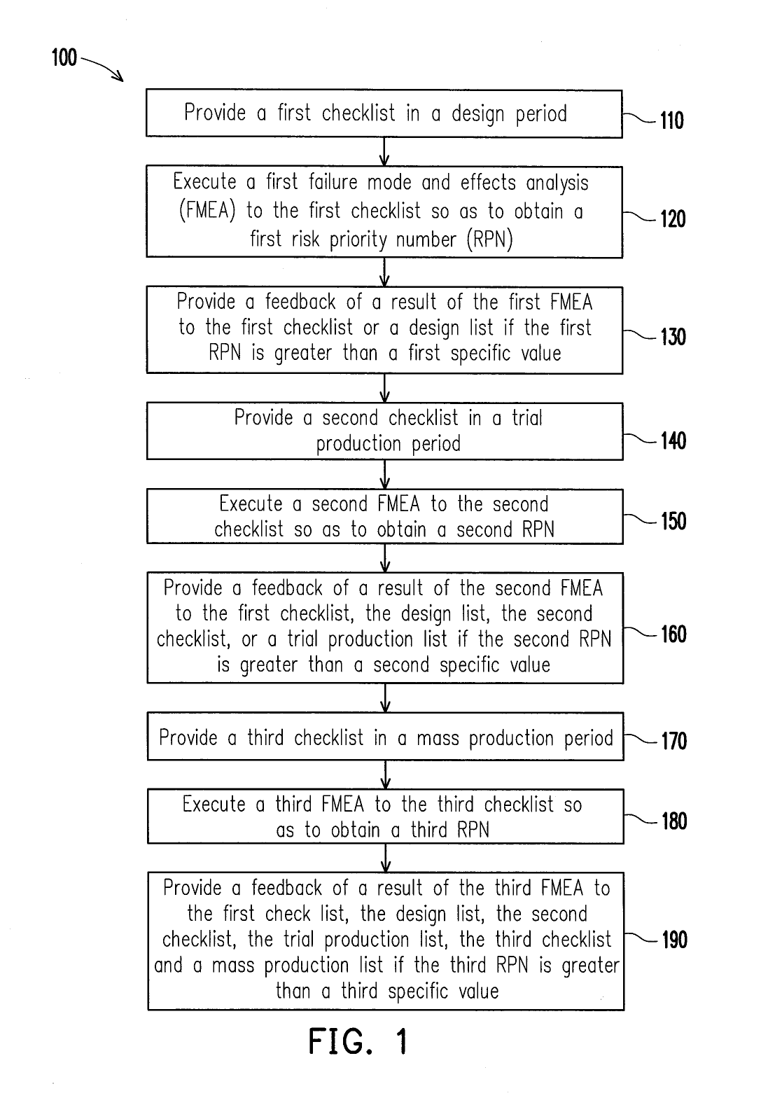

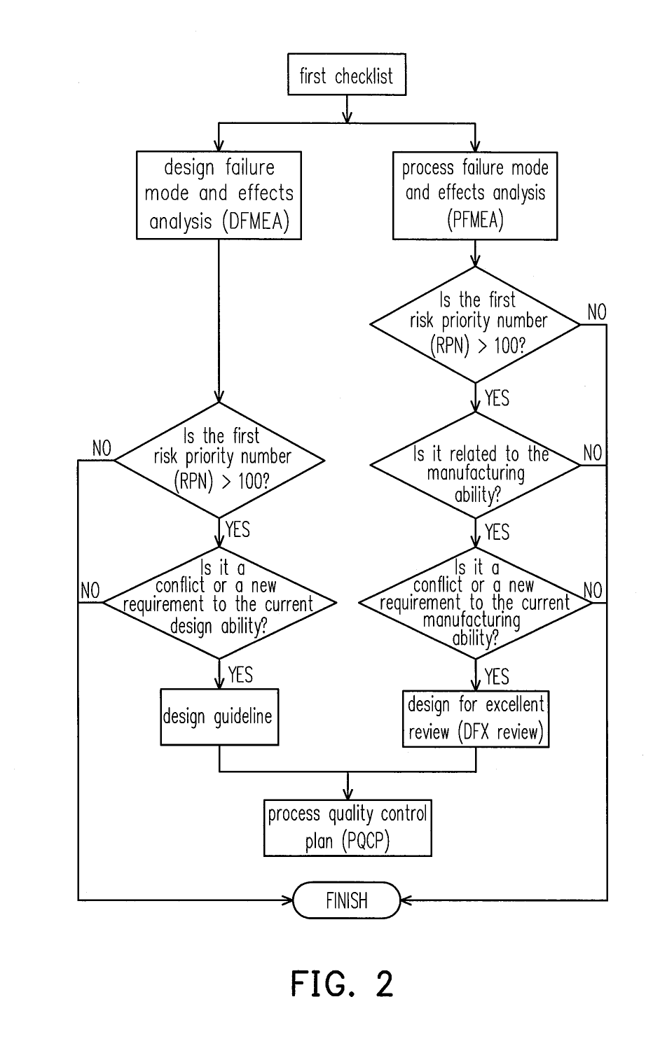

FIG. 1 is a flow diagram of a product quality improvement feedback method in accordance with an embodiment in the present invention. Within the product quality improvement feedback method in the present embodiment, an analysis is performed regarding a design period, a trail production period, and a mass production period of a product. First, the design period of the product is discussed. FIG. 2 is a flow diagram of the design period of the product quality improvement feedback method in FIG. 1. Referring to FIG. 1 and FIG. 2, the product quality improvement feedback method in the design period includes the following steps.

First, a first checklist is provided in a design period (Step 110). In the present embodiment, the first checklist is built via a quality function deployment (QFD) methodology. The quality function deployment refers to technical requirements in each period of the process of transforming customer demands into a product development. For example, the customers may demand for qualitative requirements of the product, and a design side may convert the qualitative requirements of the product from the customer demands to quantitative data via the quality function deployment methodology to form or apply to the first checklist.

Then, a first failure mode and effects analysis (FMEA) is executed to the first checklist so as to obtain a first risk priority number (RPN) (Step 120). The FMEA is an operation procedure which objective is to analyze a potential failure mode within a system so as to categorize based on the severity or to confirm the effect of the failure on the system. The FMEA is widely applied in each period of a life cycle of a product in manufacturing industry. The reason of the failure may be any errors or defects occurring during a processing process, a design procedure, or a product itself, especially the errors or defects that may affect the consumers.

In the present embodiment, the first FMEA includes a design failure mode and effects analysis (DFMEA) and a process failure mode and effects analysis (PFMEA). The DFMEA may perform a design review on a content of a first checklist regarding the design side, and the PFMEA may perform analysis on the content of the first checklist regarding an ability of a manufacturing side. After the DFMEA and the PFMEA are performed, a first RPN is obtained in each case.

The RPN is a multiplication of an event severity S, an occurrence frequency O, and a detection ranking D. The event severity S is an evaluation indicator on the severity of a potential failure mode to the customers with a 1-10 scale, ranking from no discernible effect to hazardous without warning. The occurrence frequency O refers to a frequency of occurrence for failure cause or mechanism with a 1-10 scale, ranking from extremely remote likelihood of failures to persistence of failures. The detection ranking D refers to a level of occurrence for specific failure causes or mechanisms with a 1-10 scale, ranking from certainty to impossibility of detection. The larger the RPN is, the more potential problem exists; the value is to measure a possible defect so as to adopt a possible prevention strategy to reduce critical changes for enhancing reliability.

If the first RPN (the RPN in the design period) is greater than a first specific value, then a result of the first FMEA will be feedback to the first checklist or a design list (Step 130). In the present embodiment, the first specific value is 100, and yet which is not limited thereto. In Step 130, it is categorized into the design side and the manufacturing side for further discussion.

Regarding the design side, if the first RPN (the RPN after the DFMEA) obtained from the design side is greater than 100 upon review of the design, then it represents that the current design ability does not satisfy the first checklist. This is probably because the design side has yet designed based on such new requirement, where higher risks may exist. When such condition occurs, the new requirement may be feedback to the first checklist or the design list based on a product quality improvement feedback method in the present embodiment. Certainly, the new requirement may also be feedback to both the first checklist and the design list. In the present embodiment, the design list of the design side includes a design guideline, and therefore other products with the same requirement may then be designed based on the design guideline.

Regarding the manufacturing side, if the first RPN of the manufacturing side (the RPN after the PFMEA) is found out to be greater than 100, then it is determined if it is related to a manufacturing ability. If so, then it represents that the current manufacturing ability does not satisfy the first checklist. This is probably because the manufacturing side has yet manufactured based on such new requirement, where higher risks may exist. When such condition occurs, the new requirement may be feedback to the first checklist or the design list. Certainly, the new requirement may also be feedback to both the first checklist and the design list. In the present embodiment, the design list of the manufacturing side includes a design for excellent review (DFX review). The DFX review is, for example, a design for manufacturing or a design for testing, which is demanded from the manufacturing side and provided by the design side. The design side may also update the content to the design guideline based on the demand from the manufacturing side.

Additionally, the design list in the present embodiment further includes a process quality control plan (PQCP). The PQCP is also referred as a quality control (QC) chart in the industry. The PQCP is an integration of the design guideline from the design side and the DRF review from the manufacturing side and it records key factors within the manufacturing process. Therefore, when the first RPN of the design side or the manufacturing side is greater than 100, then the new requirement will be feedback to the PQCP. The first checklist or the design list may be given feedback or updated from the new requirement based on a product quality improvement feedback method in the present embodiment. If other products with the same requirement are being developed, the updated first checklist or the design list may be adopted in the design period without repeatedly solving the same problem so as to prevent resource wastes.

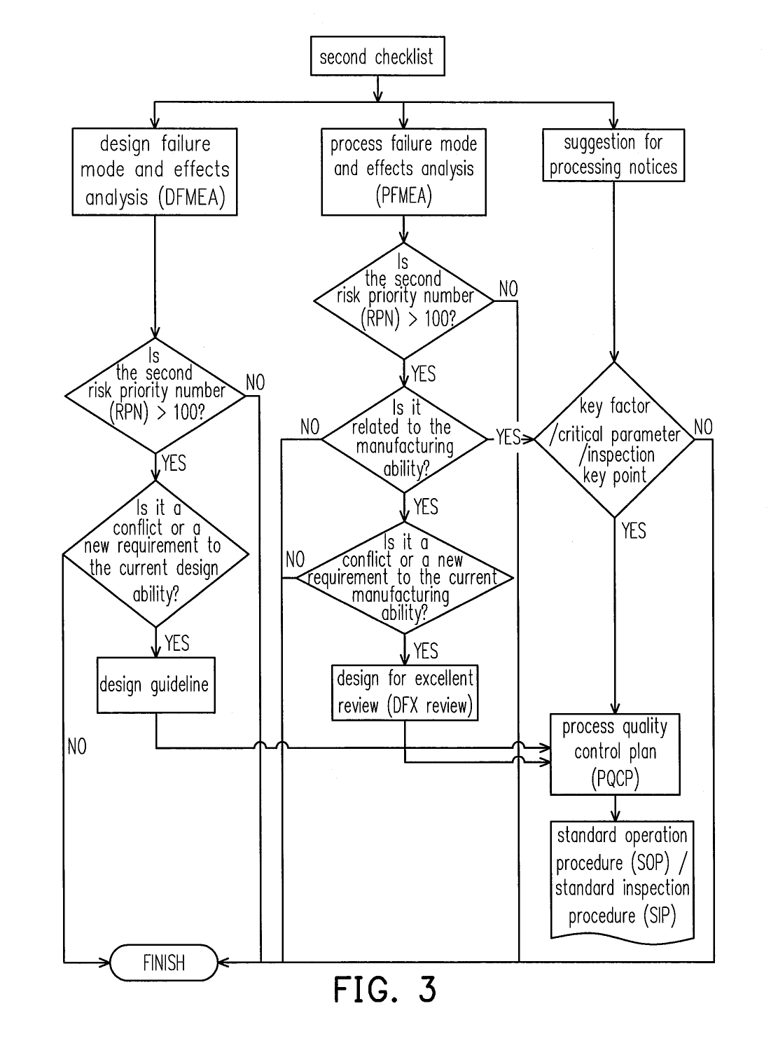

Next, the trail production period is discussed. FIG. 3 is a flow diagram of the trail production period of the product quality improvement feedback method in FIG. 1. Referring to FIG. 1 and FIG. 3, the product quality improvement feedback method in the trail production period includes the following steps. First, a second checklist is provided in a trail production period (Step 140). In the present embodiment, the second checklist includes a major issue list. A major issue list of the second checklist is a list of issues occurring in the trial production period.

Next, a second FMEA is executed to the second checklist so as to obtain a second RPN (Step 150). In the present embodiment, it is categorized into the design side and the manufacturing side for discussion. If the second checklist is associated with the design side, then a DFMEA is executed to the second checklist so as to obtain the second RPN with respect to the design side. If the second checklist is associated with the manufacturing side, then a PFMEA is executed to the second checklist so as to obtain the second risk priority number with respect to the manufacturing side.

If the second RPN is greater than a second specific value, then the result of the second FMEA will be feedback to the first checklist, the design list, the second checklist, and a trial production list (Step 160). In the present embodiment, the second specific value is 100, and yet which is not limited thereto.

Regarding the design side, if the second RPN obtained from the design side is greater than 100 upon review of the design, then it represents that the current design ability does not satisfy the second checklist or exists a risk of failure. When such condition occurs, the new requirement is feedback to the first checklist, the second checklist, the design list, or the trail production list. In the present embodiment, the trial production list includes a design guideline, a PQCP, a standard operation procedure (SOP), and a standard inspection procedure (SIP).

A new requirement is feedback to the list associated therewith, and therefore the new requirement may be updated to at least one of the first checklist, the second checklist, the design list, or the trial production list. Certainly, the new requirement may be also updated to all of the first checklist, the second checklist, the design list, and the trial production list. For example, if the new requirement is associated with the design guideline, since the design list and the trail production list both include the design guidelines, the new requirement may be updated synchronously to the design guidelines of the design list and the trial production list.

Regarding the manufacturing side, if the second risk priority number obtained from the manufacturing side is greater than 100 upon analysis, then it represents that the current manufacturing ability does not satisfy the second checklist or exists a risk of failure. When such condition occurs, the new requirement is feedback to the related parts of the first checklist, the second checklist, the design list, or the trail production list. In the present embodiment, the trial production list includes a DFX review, a PQCP, a SOP, and a SIP.

In addition, in the trial production period, the design side may provide a suggestion for processing notices for referencing purposes for a manufacturing engineering unit. If the second RPN of the PFMEA is greater than 100, then a relation between the result and the manufacturing ability is evaluated, and the content of the processing notices is determined to see if it is a key factor, critical parameter, or an inspection key point. If so, it is recorded in the PQCP, the SOP, and the SIP so as to provide a precedent for a follow-up operation in the manufacturing side. Since the product quality improvement feedback method in the present embodiment provides feedback of the new requirement to the related lists in each period, other products in a later design or manufacture may follow the related lists so as to avoid the repeated problem. Additionally, if there is a new requirement from other products, each related list may be updated based on the product quality improvement feedback method in the present embodiment so as to provide a precedent of the lists of the product quality improvement feedback method in the present embodiment for follow-up products, provide a complete content from continuous improvements, and prevent resource waste from solving the repeated problem.

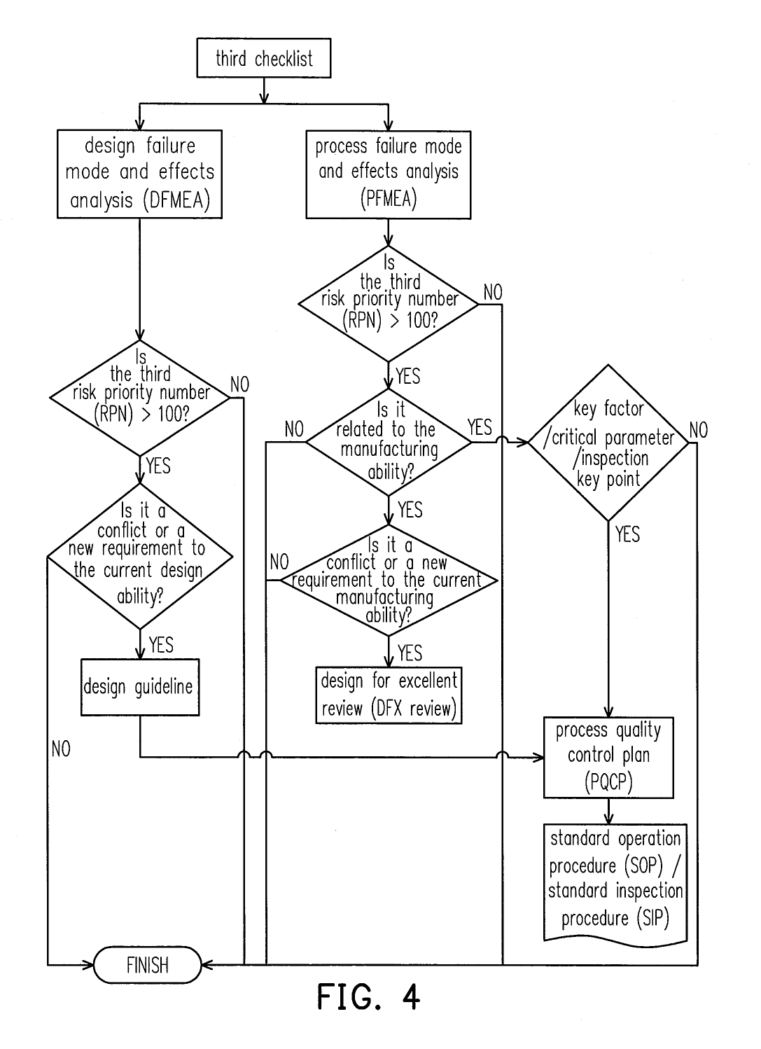

Lastly, the mass production of the product is discussed. FIG. 4 is a flow diagram of the mass production period of the product quality improvement feedback method in FIG. 1. Referring to FIG. 1 and FIG. 4, in a mass production period, the product quality improvement feedback method in the present embodiment includes the following steps. First, a third checklist is provided in a mass production period (Step 170). In the present embodiment, the third checklist includes a return materiel authorization (RMA), a major issue list (MIL), or a customer feedback. The RMA includes conditions of, for example, an end-use return, a business return, a repair return, or a dead on arrival (DOA). The end-use return includes a defective used product within or out of a guarantee period. The major issue list of the third checklist is a list of issues occurring during the mass production process.

Next, a third FMEA is executed to the third checklist so as to obtain a third RPN (Step 180). In the present embodiment, it is categorized into the design side and the manufacturing side for discussion. If the third checklist is associated with the design side, then a DFMEA is executed to the third checklist so as to obtain the third RPN with respect to the design side. If the third checklist is associated with the manufacturing side, then a PFMEA is executed to the third checklist so as to obtain the third RPN with respect to the manufacturing side.

If the third RPN is greater than a third specific value, then the result of the third FMEA will be feedback to the first checklist, the design list, the second checklist, the trial production list, the third checklist and a mass production list (Step 190). In the present embodiment, the third specific value is 100.

Regarding the design side, if the third RPN obtained from the design side is greater than 100 upon review of the design, then it represents that the current design ability does not satisfy the third checklist or exists a risk. When such condition occurs, the new requirement is feedback to the related parts of the first checklist, the second checklist, the third checklist, the design list, the trail production list, or the mass production list. In the present embodiment, the mass production list includes a design guideline.

Regarding the manufacturing side, if the third risk priority number obtained from the manufacturing side is greater than 100 upon analysis, then it represents that the current manufacturing ability does not satisfy the third checklist or exists a risk of failure.

When such condition occurs, the new requirement is feedback to the related parts of the first checklist, the second checklist, the third checklist, the design list, the trail production list or the mass production list. In the present embodiment, the mass production list includes a DFX review, a PQCP, a standard operation procedure (SOP), and a standard inspection procedure (SIP). For example, if it is related to the manufacturing ability, then a key factor, critical parameter, or inspection key point related to the manufacturing ability will be recorded in the PQCP, the SOP, or the SIP so as to provide a precedent for a follow-up operation in the manufacturing side.

To sum up the above, the product quality improvement feedback method in the present invention executes a FMEA to a design side and a manufacturing side so as to obtain a RPN in a design period, a trial production period, and a mass production period respectively. If the RPN is greater than a specific number, then the result of the FMEA is feedback to a checklist, a product design list, a trial production list, or a mass production list in each period so as to integrate problems and solutions systematically. Therefore, other products in a follow-up production may prevent the problem and avoid repeatedly solving the same problem that causes resource wastes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A product quality improvement feedback method comprising:
providing a first checklist in a design period;
executing a first failure mode and effects analysis to the first checklist so as to obtain a first risk priority number;
providing a feedback of a result of the first failure mode and effects analysis to the first checklist or a design list if the first risk priority number being greater than a first specific value;
providing a second checklist in a trial production period;
executing a second failure mode and effects analysis to the second checklist so as to obtain a second risk priority number;
providing a feedback of a result of the second failure mode and effects analysis to the first checklist, the design list, the second checklist, or a trial production list if the second risk priority number being greater than a second specific value;
providing a third checklist in a mass production period;
executing a third failure mode and effects analysis to the third checklist so as to obtain a third risk priority number; and
providing a feedback of a result of the third failure mode and effects analysis to the first check list, the design list, the second checklist, the trial production list, the third checklist or a mass production list if the third risk priority number being greater than a third specific value.

2. The product quality improvement feedback method of claim 1, wherein the step of providing the first checklist comprises:
building the first checklist via a quality function deployment methodology.

3. The product quality improvement feedback method of claim 1, wherein the first failure mode and effects analysis comprises a design failure mode and effects analysis.

4. The product quality improvement feedback method of claim 3, wherein the design list comprises a design guideline and a process quality control plan.

5. The product quality improvement feedback method of claim 1, wherein the first failure mode and effects analysis comprises a process failure mode and effects analysis.

6. The product quality improvement feedback method of claim 5, wherein the design list comprises a design for excellent review and a process quality control plan.

7. The product quality improvement feedback method of claim 1, wherein the second checklist comprises a major issue list.

8. The product quality improvement feedback method of claim 1, wherein the second failure mode and effects analysis comprises a design failure mode and effects analysis.

9. The product quality improvement feedback method of claim 8, wherein the trial production list comprises a design guideline, a process quality control plan, a standard operation procedure, and a standard inspection procedure.

10. The product quality improvement feedback method of claim 1, wherein the second failure mode and effects analysis comprises a process failure mode and effects analysis.

11. The product quality improvement feedback method of claim 10, wherein the trial production list comprises a design for excellent review, a process quality control plan, a standard operation procedure, and a standard inspection procedure.

12. The product quality improvement feedback method of claim 1, wherein the third checklist comprises a return materiel authorization, a dead on arrival, or a major issue list.

13. The product quality improvement feedback method of claim 1, wherein the third failure mode and effects analysis comprises a design failure mode and effects analysis.

14. The product quality improvement feedback method of claim 13, wherein the mass production list comprises a design guideline.

15. The product quality improvement feedback method of claim 1, wherein the third failure mode and effects analysis comprises a process failure mode and effects analysis.

16. The product quality improvement feedback method of claim 15, wherein the mass production list comprises a design for excellent review, a process quality control plan, a standard operation procedure, or a standard inspection procedure.

17. The product quality improvement feedback method of claim 1, wherein the first specific value, the second specific value, and the third specific value are 100.
